(19) United States
(12) Patent Application Publication
(10) Pub. No.: US 2026/0003872 A1
(43) Pub. Date: Jan. 1, 2026

(54) Batch Query Partitioning for Multi-engine Execution

(71) Applicant: PayPal, Inc., San Jose, CA (US)

(72) Inventors: Yichao Yuan, Shanghai (CN); Ying Yue, Shanghai (CN); Delin Liu, Shanghai (CN); Xiaojun Luan, Shanghai (CN); Pengshan Zhang, Shanghai (CN)

(21) Appl. No.: 18/814,808

(22) Filed: Aug. 26, 2024

(30) Foreign Application Priority Data
Jun. 27, 2024 (WO) PCT/CN2024/101898

(51) Int. Cl. G06F 16/2455; G06F 16/22; G06F 16/29

(52) U.S. Cl. CPC G06F 16/24556; G06F 16/2228; G06F 16/29

(57) ABSTRACT

Techniques are disclosed relating to partitioning batch queries for multi-engine execution. A system receives a batch query specifying query data and including a request for geospatial data for regions corresponding to the query data. Based on locations corresponding to the query data, the system partitions the query data into subsets. The system may assign the subsets of query data to query engines corresponding to the locations of the subsets. The system may cause the engines to retrieve geographic region data corresponding to the locations included in the subsets, where the retrieving is performed by a given query engine for a corresponding subset by accessing an in-memory index of the given engine that stores geographic region data for a geographic partition within which the corresponding subset of query data is located. The system may store region data retrieved by the engines for the subsets in an aggregated data store.

### PRIORITY CLAIM

The present application claims priority to PCT Appl. No. PCT/CN2024/101898, entitled “BATCH QUERY PARTITIONING FOR MULTI-ENGINE EXECUTION”, filed Jun. 27, 2024, which is incorporated by reference herein in its entirety.

### BACKGROUND

### Technical Field

This disclosure relates generally to improvements in querying techniques, and, more specifically, to query partitioning techniques for execution by multiple engines to improve efficiency of querying on geospatial data.

### Description of the Related Art

In various computing scenarios, a database may contain geographic locations of one or more physical real-world entities. When querying a database to identify geographic information of different entities, performance of the search may be negatively impacted by a variety of factors. For example, when such databases include large numbers of geographic locations as well as a plethora of other geographic information for the locations, search performance may be reduced beyond desired or acceptable limits, and computer software applications that rely on the database query may be negatively impacted. This may be particularly pertinent to batch queries attempting to retrieve a large amount of geographic data for multiple different sets of inputs.

### BRIEF DESCRIPTION OF THE DRAWINGS

FIG. 1 is a block diagram illustrating an example system configured to execute a partitioned batch query, according to some embodiments.

FIG. 2 is a block diagram illustrating an example query module, according to some embodiments.

FIG. 3 is a diagram illustrating example partitions, according to some embodiments.

FIG. 4 is a diagram illustrating an example batch query and example geographic cells, according to some embodiments.

FIG. 5 is a diagram illustrating an example in-memory index, according to some embodiments.

FIG. 6 is a block diagram illustrating an example system configured to execute multiple types of queries, according to some embodiments.

FIG. 7 is a flow diagram illustrating an example method for partitioning a batch query and executing the partitioned batch query using multiple query engines, according to some embodiments.

### DETAILED DESCRIPTION

Currently available databases often do not provide sufficient performance for large batch queries, particularly when the scale of these batch queries requires thousands of queries per second to a backend database. For example, if a batch query includes commands to retrieve thousands of separate sets of data from a backend database, traditional database systems often throw error messages when attempting to execute such queries due to their capacity being reached. This problem is particularly true if each command of the batch query is retrieving a large portion of data from the backend database. Efficient execution of queries is especially important in situations in which service level agreements (SLAs) mandate a certain number of queries that must be executed within a given second. For example, traditional database systems may not be able to execute more than one hundred, one thousand, ten thousand, etc. queries per second (QPS). Applicant recognizes that the inability to perform efficient batch queries presents a significant opportunity for improvement in database systems.

Queries performed on a database are often used to locate a specific set of data stored in the database, based on a set of search parameters. For example, if a database stores weather data, then a batch query on the database that includes a command for retrieving weather data for a geographic coordinate indicating a location in Austin, Texas, would return weather patterns for this city. As another example, if the database were to store geographic region data for various different regions, the query parameters might specify multiple different geographic coordinates for many different locations from which region data is desired.

In order to handle large scale queries, the disclosed system alters existing distributed database systems by building a middleware between a backend database and front-end data processing systems wishing to execute large scale batch queries on the backend database. In order to efficiently handle batch queries, the disclosed system divides batch queries into smaller subsets of query data that are then assigned to a plurality of different query engines (which can be spun up or shut down depending on capacity requirements of the batch query) based on locations corresponding to the data included in the separate subsets of query data. As discussed in further detail below, the disclosed techniques partition geographic locations so that query data from a batch corresponding to the different geographic partitions can be assigned and executed by query engines assigned to execute queries within those geographic partitions. In this way, the disclosed batch querying techniques are not only more efficient than existing querying techniques, but also provide scalability. For example, new query engines can be spun up by the disclosed system based on both the size of different batch queries and the number of batch queries received for processing at any given time.

The disclosed techniques further implement in-memory indexing. These indexes act as caches that are local to respective query engines. For example, a given query engine maintains its own in-memory index storing geographic region data for one or more regions located within a geographic partition assigned to the given query engine. After handling a subset of query data for a first batch query, a query engine is able to first access its in-memory index to determine whether the index already stores geographic region data for subsequent batch queries. In this way, the disclosed query engines not only efficiently execute portions of a batch query in parallel, but also implement in-memory indexes to more efficiently retrieve geographic region data requested by the batch query. This, in turn, may advantageously reduce the amount of computing resources necessary to implement a given batch query. For example, because the disclosed system does not have to perform resource-intensive data retrievals from a backend database for each batch query, this system uses less resources than traditional database systems when executing batch queries. By implementing in-memory indexing, the disclosed query engines are able to perform quick data retrievals from their internal indexes, thereby using fewer computing resources for each batch query than non-indexing query techniques.

### Example Computer System

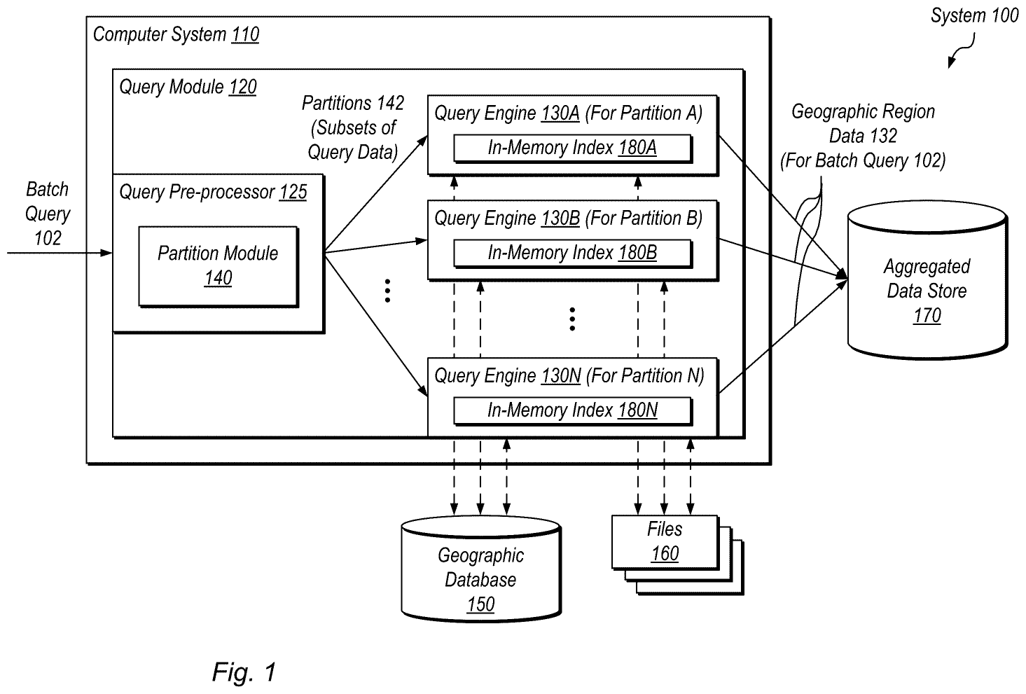

FIG. 1 is a block diagram illustrating an example system configured to execute a partitioned batch query. In the illustrated embodiment, system 100 includes aggregated data store 170, geographic database 150, files 160, and a computer system 110, which in turn includes query module 120. In various embodiments, computer system 110 is configured to execute query module 120 to retrieve geospatial data for various batch queries. Query module 120, in the illustrated embodiment, includes query pre-processor 125 and multiple query engines 130A-130N.

Computer system 110, in the illustrated embodiment, receives a batch query 102 requesting geospatial data. In some embodiments, batch query 102 is received from a client computing device. For example, batch query 102 is received from an application of system 100 executing on a client computing device, such as a desktop computer, of an individual wishing to analyze geospatial data for multiple different entities. In this example, the individual may be a software developer or a system administrator generating and analyzing reports on geospatial data. In response to receiving batch query 102, computer system 110 executes query module 120 to retrieve geospatial data based on batch query 102.

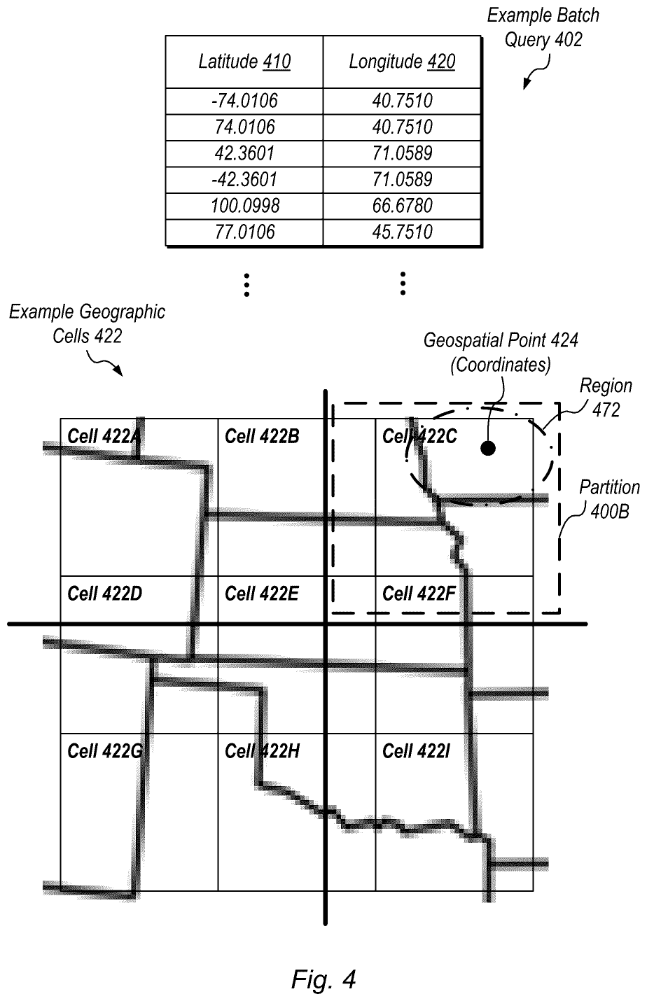

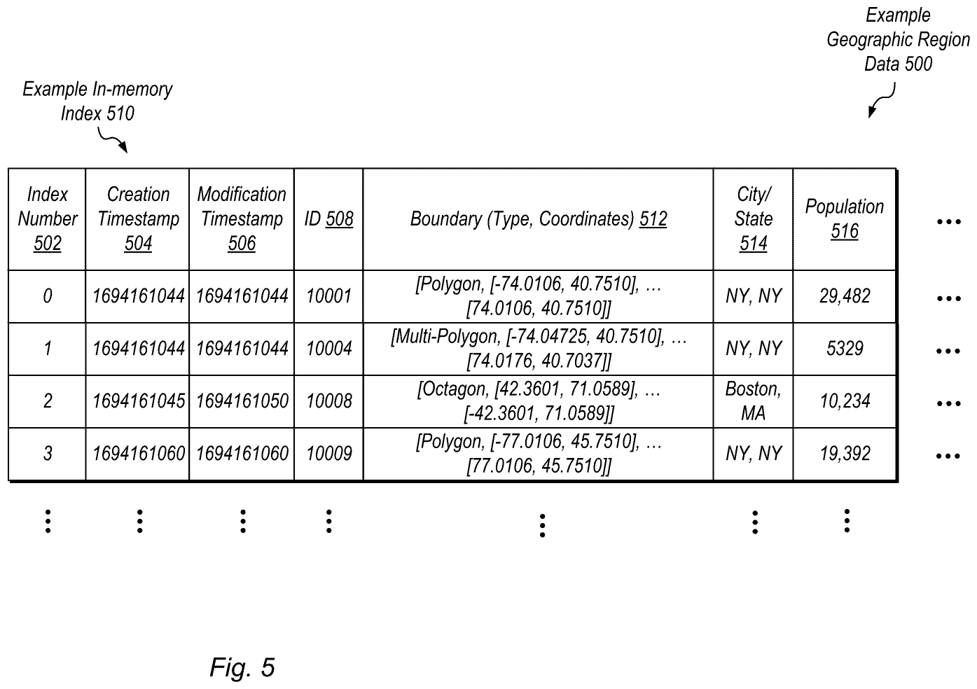

In various embodiments, batch query 102 includes a set of query data. For example, this set of query data includes a list of geographic coordinates. These coordinates may specify locations in any of various neighborhoods, towns, cities, states, countries, etc. In various embodiments, batch query 102 specifies a plurality of different geographic locations for which an entity would like geospatial data, such as data for a specific geographic region. As used herein, the term “geospatial data” refers to any of various types of geographic information including geographic variables, coordinates, descriptions, etc. As used herein, the term “geographic region data” refers to geographic data that is a subset of the umbrella term geospatial data and includes data for a given geographic region. Example geographic region data is discussed in further detail below with reference to FIG. 5. Geographic region data may include, for example, one or more types of the following types of geographic variables: index number, creation timestamp, modification timestamp, region identifier, boundary type, boundary coordinates, city, state, population, population per square mile, region shape area, and region shape length. As used herein, the term “geographic region” is intended to be construed according to its well-understood meaning which includes a region that encompasses a specific area such as is a zip code, neighborhood, county, city, state, country, etc. An example geographic region is shown in FIG. 4. Geographic region data includes, for example, data corresponding to a geographic region in which a location specified by geographic coordinates is located.

Computer system 110, in the illustrated embodiment, executes query module 120 to perform geolocation queries on a geographic database 150 (or one or more other data repositories such as files 160) based on batch query 102. In the illustrated embodiment, query module 120 executes query pre-processor 125 to partition batch query 102 which includes a set of query data.

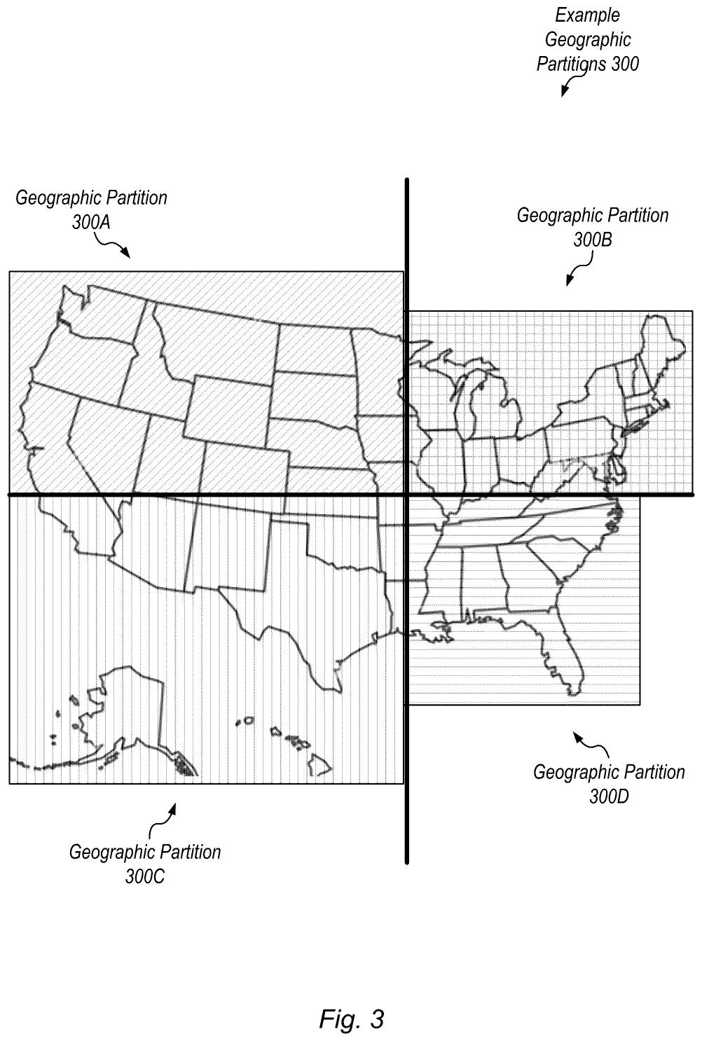

Query pre-processor 125, in the illustrated embodiment, executes partition module 140 to generate partitions 142 of batch query 102. These partitions 142 include subsets of a set of query data of in batch query 102. In the illustrated embodiment, query pre-processor 125 inputs partitions 142 of query data into a plurality of different query engines 130A-130N according to their corresponding regions. For example, query pre-processor 125 inputs a first partition 142 (i.e., partition A as shown in FIG. 1) into query engine 130A based on the geographic coordinates included in the first partition 142 (i.e., a subset of batch query data) being located in a geographic region that falls within a geographic partition assigned to query engine 130A. Geographic partitions, which are different than the partitions of query data 142 shown in FIG. 4, are discussed in further detail below with reference to FIGS. 3 and 4. As discussed in further detail below, geographic partitions are generated from map data and these geographic partitions are assigned to different query engines such that these query engines execute portions of batch queries whose geographic coordinates are located within the respective assigned geographic partitions.

Query engines 130A-130N individually maintain in-memory indexes 180A-180N for retrieving geographic region data for their respective geographic partitions. For example, query engine 130A maintains in-memory index 180A for a first partition by indexing geographic region data, for a first geographic region, which was retrieved from geographic database 150 or files 160 for a plurality of prior batch queries. The geographic region data stored in index 180A is then usable to serve various future batch queries with one or more subsets of query data corresponding to the geographic region for which data is stored in index 180A. In the illustrated embodiment, if the partition 142 input to query engine 130A is the first subset of query data that engine 130A has received, then this engine 130A retrieves geographic region data from geographic database 150 or files 160 and stores it in index 180A. The geographic region data stored in index 180A is then usable for future queries corresponding to the partition handled by query engine 130A. In such situations, query engine 130A also stores the retrieved geographic region data 132 in aggregated data store 170.

In some embodiments, query pre-processor 125 and query engines 130A-130N are executed by query module 120 using a programming methodology that takes large amounts of data (often referred to as big data) and processes the data using a parallel, distributed algorithm. For example, query module 120 executes query pre-processor 125 and query engines 130A-130N using a map-reduce software framework. In this example, query pre-processor 125 is the map portion of the map-reduce framework that partitions a set of query data into smaller subsets and query engines 130A-130N are the reduce portion of the map-reduce framework that executes multiple different server instances in parallel to process the smaller subsets of query data. In this way, the disclosed techniques may advantageously improve processing efficiency by breaking down a large batch of data into smaller pieces that are executable in parallel.

In some embodiments, query pre-processor 125 generates a partition 142 that does not have a corresponding query engine 130. For example, if query module 120 receives a batch query that includes geographic coordinates in a new geographic region not yet queried on, query module 120 spins up a new query engine that builds an in-memory index based on geographic region data for this new region. Such techniques allow query module 120 to service the batch query that includes coordinates located in the new geographic region without burdening previously existing query engines querying on other geographic regions. Over time, query module 120 may adjust the shape and size of geographic regions. Based on this adjustment, may spin up or break down query engines according to the number of geographic regions for which data is needed to be retrieved. As one example, during high volume traffic times (e.g., computer system 110 is receiving a large volume of batch queries), query module 120 may spin up multiple new query engines configured to handle smaller geographic regions than previous geographic regions. In this way, batch queries are more efficiently partitioned and serviced than if query module 120 executed a smaller number of query engines to handle larger geographic regions. In this example, query engines rebuild their in-memory indexes according to their assigned new, smaller geographic regions.

In the illustrated embodiment, after retrieving geographic region data 132 from either in-memory indexes 180A-180N or from geographic database 150 or files 160, query engines 130A-130N store the geographic region data 132 for batch query 102 in aggregated data store 170. In some embodiments, information indicating the location of aggregated data store 170 is shared with an entity that submitted batch query 102. In such embodiments, the entity is able to access the geographic region data 132 retrieved for their batch query. In other embodiments, system 100 retrieves the geographic region data 132 aggregated for batch query 102 and transmits this data to the entity (e.g., a computing device of a data analyst) that submitted batch query 102. Geographic database 150, shown in the illustrated embodiment, is a non-relational database (e.g., Aerospike™, Apache Cassandra™, Apache Hbase™, MongoDB™, etc.) that stores data as key-value pairs. For example, geographic database 150 stores rows of key-value pairs, where the key column of the table stores values for various sets of geographic coordinates and the value column of the table stores geographic region data corresponding to the geographic coordinates.

Note that partitioning and executing batch queries using multiple query engines on geospatial data is one non-limiting example embodiment of the querying that may be performed by system 110. In various embodiments, system 110 may perform queries on: transaction data (e.g., electronic monetary transactions), graphical data (e.g., a transaction network graph having nodes representing entities and edges representing the electronic transactions between the entities), weather data (e.g., current or future weather patterns for a plurality of locations), merchant data (e.g., merchant locations and other merchant data for a given geographic region), promotion data (including corresponding locations), health data (e.g., for individuals in a given city), etc.

In this disclosure, various “modules” operable to perform designated functions are shown in the figures and described in detail (e.g., partition module 140, query engines 130A-130N, division module 220 (discussed below), mapping module 230 (discussed below), etc.). As used herein, a “module” refers to software or hardware that is operable to perform a specified set of operations. A module may refer to a set of software instructions that are executable by a computer system to perform the set of operations. A module may also refer to hardware that is configured to perform the set of operations. A hardware module may constitute general-purpose hardware as well as a non-transitory computer-readable medium that stores program instructions, or specialized hardware such as a customized ASIC. The term “engine” may also be used interchangeably with the term “module” herein. For example, as used herein, the term “query engine” refers to a set of software instructions that are executable by one or more server instances. A single query engine may be run on a given server instance or multiple query engines may be run by a given server instance.

### Example Query Module

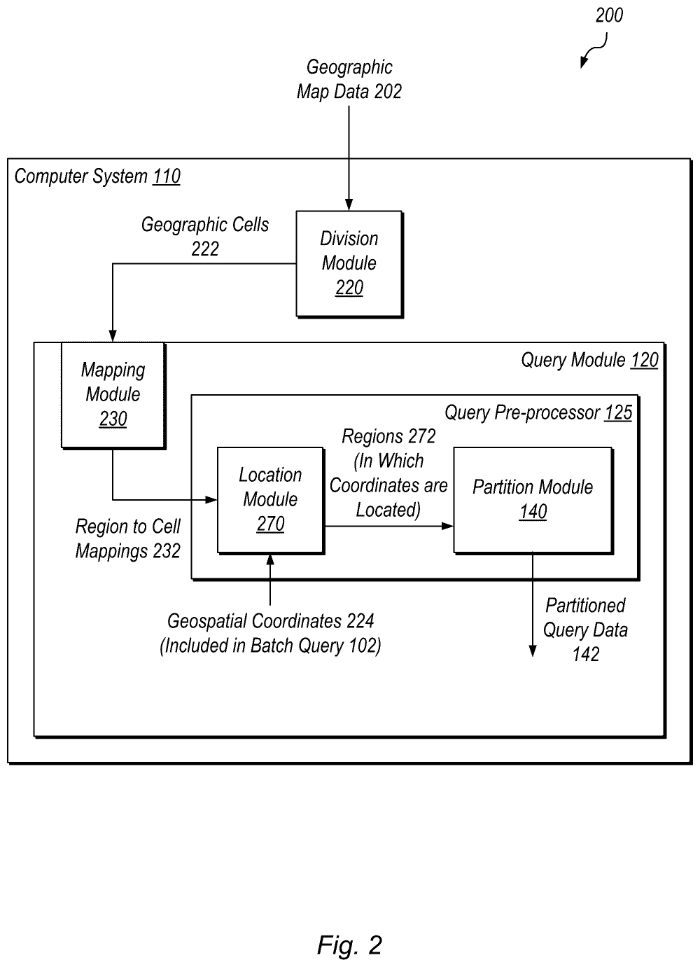

FIG. 2 is a block diagram illustrating an example query module. In the illustrated embodiment, system 200 includes computer system 110, which in turn includes division module 220 and query module 120. In the illustrated embodiment, query module 120 includes mapping module 230 and query pre-processor 125, which in turn includes location module 270 and partition module 140.

Division module 220, in the illustrated embodiment, receives geographic map data 202. The geographic map data 202 includes a map depicting the surface of the earth. For example, geographic map data 202 includes a geographic chart depicting a map of a city, state, country, etc. This map may be retrieved by computer system 110 from a database or from a file online, e.g., from a website. Computer system 110 then inputs the map to division module 220. Division module 220, in the illustrated embodiment, divides the surface of the earth into small squares referred to herein as “cells,” examples of which are shown in FIG. 4 and discussed in detail below. In various embodiments, the map data may depict the surface of one or more planets other than the earth. For example, the disclosed techniques may be used to retrieve geographic region data for locations on other planets or in other solar systems. In various embodiments, division module 220 is used to divide various different non-spherical surfaces (e.g., surfaces other than a sphere or planet). Division module 220, in the illustrated embodiment, sends geographic cells 222 dividing the surface of the earth to mapping module 230.

Mapping module 230, in the illustrated embodiment, generates mappings 232 between one or more geographic regions 272 and geographic cells 222. For example, as discussed in further detail below with reference to FIG. 4, mapping module 230 maps one or more geographic regions 272 (e.g., one or more neighborhoods or cities) encompassed by a given geographic cell 222 to that geographic cell. Said another way, mapping module 230 identifies which geographic regions 272 are located within which geographic cells 222.

Query pre-processor 125, in the illustrated embodiment, receives geographic region to geographic cell mappings 232 from mapping module 230 and inputs these mappings into location module 270. Location module 270 also receives a plurality of geographic coordinates 224 included in batch query 102 (discussed above with reference to FIG. 1) and identifies geographic regions 272 in which the geographic coordinates 224 are located. For example, location module 270 determines that a geographic coordinate 224 indicates a location that is within a given geographic region 272 (which in turn is located within a given geographic cell 222 according to mappings 232).

Partition module 140, in the illustrated embodiment, receives regions 272 in which the geographic coordinates 224 are located and, based on these regions, identifies which partition this region is encompassed by (note that partitions are discussed in further detail below with reference to FIG. 3). After identifying a partition in which a region 272 (i.e., one or more geographic coordinates 224) is located, partition module 140 assigns this region 272 (and its corresponding coordinates from batch query 102) to the identified partition. After assigning different geographic coordinates 224 to different partitions based on their regions, partition module 140 outputs partitioned query data 142, which query pre-processor 125 then assigns to different query engines 130 for query execution as discussed above with reference to FIG. 1. For example, if query engine 130A handles query execution for partition A, then geographic coordinates 224 identified by partition module 140 as being located in a geographic region that is in turn located within partition A will be assigned to query engine 130A for execution (to locate geographic region data corresponding to the geographic coordinates 224).

### Example Partitions

FIG. 3 is a diagram illustrating example geographic partitions 300. In the illustrated embodiment, four example partitions 300A-300D are shown dividing the United States of America, including Alaska and Hawaii, into four different portions. In the illustrated embodiment, partition A encompasses the top left portion of the US, partition 300B encompasses the top right portion of the US, partition 300C encompasses the bottom left portion of the US including Alaska and Hawaii, and, finally, partition 300D encompasses the bottom right portion of the US. In disclosed embodiments, query pre-processor 125 executes partition module 140, shown in FIG. 1, to generate partitions such as the example geographic partitions 300A-300D and assigns these partitions to four different query engines 130. For example, geographic partition 300A is assigned to a first query engine. Based on this assignment, when a batch query is received, computer system 110 determines which subsets of query data to assign to which query engine. For example, computer system 110 determines that geographic coordinates included in a first subset of query data of a given batch query are located in partition 300A and, accordingly, sends the first subset of query data to a first query engine to which partition 300A has been assigned.

### Example Batch Query and Geographic Cells

FIG. 4 is a diagram illustrating an example batch query and example geographic cells. In the illustrated embodiment, an example batch query 402 is shown with a list of different pairs of latitudes 410 and longitudes 420. In the illustrated embodiment, batch query 402 includes six different pairs of latitudes 410 and longitudes 420. In various embodiments, however, batch queries submitted to computer system 110 may include any number of coordinates to be searched on. As one particular example, the first coordinates included in batch query 402 include a latitude 410 of “−74.0106” and a longitude 420 of “40.7510.”

In addition to example batch query 402, the illustrated embodiment shows example geographic cells 422, an example region 472, an example geospatial point 424 (corresponding to coordinates included in batch query 402), and an example partition 400B (similar to the example partitions shown in FIG. 3). In the bottom portion of FIG. 4, a plurality of different geographic cells 422A-422I are shown. These geographic cells 422A-422I divide the surface of the earth into small squares. Within these cells, several different geographic regions may be encompassed. In the illustrated embodiment, region 472 is encompassed by cell 422C, which in turn is encompassed by partition 400B. For example, cell 422C encompasses four different regions (only one of which is shown as region 472). After determining which cell a geospatial point 424 is located in, the disclosed techniques then determine which region within this cell the geospatial point is located. Based on this determination, the disclosed system (e.g., computer system 110 discussed above with reference to FIG. 1) retrieves region data for the geospatial point 424 from batch query 402.

In the context of FIG. 1, query engines 130 determine which regions (e.g., region 472) are encompassed by their assigned geographic partition 142 and construct indexes to store region data for the determined regions. The disclosed techniques take a geospatial point specified by a given set of geographic coordinates (e.g., a latitude 410 of “−74.0106” and a longitude 420 of “40.7510”) included in a batch query 402 and determine which of the cells 422A-422I the geospatial point falls into. The determined geospatial cell is then used to determine which region within this cell the geospatial point falls into. This determination is then used by a given query engine to retrieve region data stored in the in-memory index of the given query engine and corresponding to the determined region. In the example shown in FIG. 4, geospatial point 424 falls in cell 422C and is located in region 472, which in turn is located in partition 400B.

Example in-Memory Index

FIG. 5 is a diagram illustrating an example in-memory index. In the illustrated embodiment, example geographic region data 500 stored in a given in-memory index 510 is shown. In-memory index 510 is one example of the in-memory indexes 180A-180N generated and maintained by query engines 130A-130N for different geographic partitions as discussed above with reference to FIG. 1.

In-memory index 510, in the illustrated embodiment, includes several columns for different geographic variables with rows of values for the different variables included in the example geographic region data 500. Note that while FIG. 5 shows seven different geographic variables, any of various numbers of variables may be stored in in-memory index 510 for one or more geographic regions included in a given geographic partition corresponding to in-memory index 510. Similarly, while the in-memory index shown in FIG. 5 is shown to store four different rows of geographic region data for four geographic regions, index 510 may include more than four rows of data storing geographic region data for any number of geographic regions.

In the illustrated embodiment, the first row of in-memory index 510 stores data for a geographic region having an index number 502 of “0,” a creation timestamp 504 of “1694161044,” a modification timestamp 506 of “1694161044.” The creation timestamp 504 and the modification timestamp 506 are the same for this region, indicating that the geographic data for this particular region has not been altered since its creation and storage within in-memory index 510. In various embodiments, the different timestamps are used by geographic database 150 to keep track of different geographic records. The first row of in-memory index 510 further includes an identifier (ID) 508 of “10001,” a boundary 512 of type “polygon” with the coordinates of the boundary beginning at point “−74.0106, 40.7510” and ending at point “74.0106, 407510.” In various embodiments, the ID 508 provides differentiation between the various records of the in-memory index 510. For example, an ID 508 of a given record could be used to locate that record within the index 510. {Further, the first row of index 510 includes a city and state 514 of “NY, NY” corresponding to the region (e.g., a city in which the region is located or which encompasses the region) as well as a population 516 of the region which is “29,482.” Similarly, the next three rows of in-memory index 510 store geographic region data 500 for three different regions corresponding to the states of New York and Massachusetts.

### Example Geolocation System

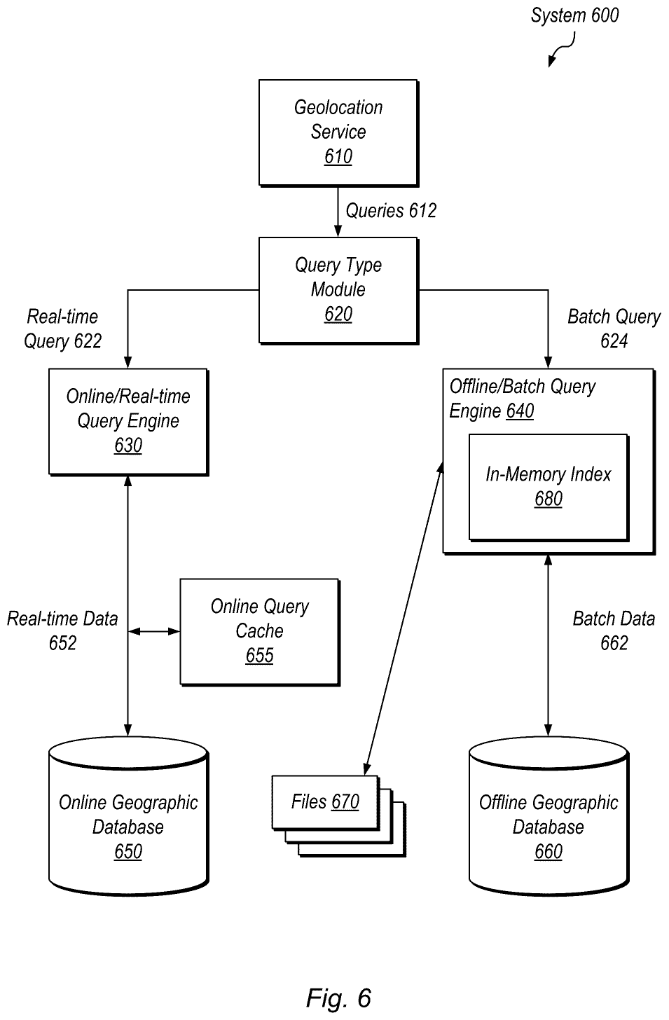

FIG. 6 is a diagram illustrating an example system configured to execute multiple types of queries. In the illustrated embodiment, an example system 600 includes geolocation service 610, query type module 620, online/real-time query engine 630, online query cache 655, online geographic database 650, files 670, offline geographic database 660, and offline/batch query engine 640, which in turn includes in-memory index 680.

In addition to performing offline batch queries to retrieve and manage geographic region data as discussed above with reference to FIGS. 1-5, the disclosed techniques perform caching of online, real-time queries to quickly retrieve geographic data (e.g., geographic coordinates of different entities on a map). System 600 is one example of system 100, shown in FIG. 1, that may perform multiple types of queries. The disclosed multi-engine query indexing techniques may improve user experience by providing query results more quickly than querying techniques that do not implement in-memory caching by multiple different engines, while also providing geographic data results for different types of queries (e.g., both offline batch queries and online, real-time queries). As one example of an online query such as a query performed by the online/real-time query engine 630 shown in FIG. 6, a user of a computing device opens an application that processes electronic communications (e.g., electronic transactions such as person-to-person transactions provided by the PayPal™ application) and the application displays a map to the user showing geographic locations of various entities in which the user might be interested. For example, this map shows the locations of various merchants that are near the location of the user and with which the user might wish to communicate. This application submits requests for the user to locate entities to geolocation service 610, which is a server of system 600 interfacing between client applications and the query type module 620 shown in FIG. 6.

In the illustrated embodiment, geolocation service 610 submits queries 612 to query type module 620 based on requests received from client computing devices. Query type module 620 determines whether respective queries 612 are real-time queries 622 or batch queries 624. Query type module 620 sends real-time queries 622 to online/real-time query engine 630 and batch queries 624 to offline/batch query engine 640 in the illustrated embodiment. Online/real-time query engine 630 executes commands included in real-time query 622 to retrieve real-time data 652 from either an online query cache 655 storing geographic coordinates for different entities (e.g., merchants) or from online geographic database 650. Online geographic database 650, for example, may be implemented using a non-relational database such Apache HBase™, while offline geographic database 660 may be implemented using a non-relational database such as Acrospike™. Note that Apache Hbase and Acrospike are non-limiting examples of the types of non-relational databases that may be used to implement both online and offline queries. In various embodiments, online/real-time query engine 630 returns real-time data 652 retrieved from cache 655 or database 650 to geolocation service 610 (this data transmission is not shown in FIG. 6).

Offline/batch query engine 640 receives batch queries 624 from query type module 620 and executes these batch queries to retrieve batch data 662 from offline geographic database 660 or from files 670. As discussed above with reference to FIG. 1, offline/batch query engine 640 executes a plurality of different query engines, such as query engines 130A-130N to execute a single batch query having geographic coordinates in multiple different geographic regions. After retrieving batch data 662, offline/batch query engine 640 stores the batch data 662 in in-memory index 680 (or multiple different in-memory indexes depending on the partition corresponding to the different batch data retrieved as discussed above with reference to FIG. 1). In some embodiments, offline/batch query engine 640 attempts to retrieve batch data 662 (e.g., geographic region data such as example data 500 shown in FIG. 5) from in-memory index 680 prior to performing the slower, more resource-intensive retrieval of batch data from either offline geographic database 660 or files 670. In some embodiments, offline/batch query engine 640 transmits batch data 662 to geolocation service 610 (this transmission is not shown in FIG. 6) in response to batch queries 624. In other embodiments, offline/batch query engine 640 stores the retrieved batch data 662 as a file in a data repository, such as the aggregated data store 170 discussed above with reference to FIG. 1 and transmits a notification to geolocation service 610 indicating the location of the file. In this way, geolocation service 610 is able to retrieve batch data 662 from the data repository by following the location information provided by engine 640 in order to retrieve the batch data 662 once its retrieval is completed by engine 640.

In various embodiments, the disclosed techniques may advantageously provide consistent performance for geospatial queries by localizing data geographically (i.e., via partition assignments to different query engines as discussed above with reference to FIGS. 1 and 3) to improve query efficiency. Such techniques also reduce overall usage of computing and memory resources by reducing the number of retrievals performed on backend databases such as offline geographic database 660 via the use of in-memory indexes such as in-memory index 680 and in-memory indexes 180A-180N. As one specific example, batch queries performed using traditional techniques on the backend database are generally able to execute 1000 queries per second (QPS), with an average speed of 3.42 seconds per query and a P99 probability of 8.9 milliseconds, indicating that 99 percent of the 1000 queries executed within a given second were executed within 8.9 milliseconds. In contrast and in the context distributed databases, such as Acrospike, batch queries performed for a single node of the distributed database using the disclosed multi-query engine in-memory data indexing performs 1000 queries per second with an average speed of 0.97 milliseconds with a P99 probability of 1.58 milliseconds, indicating that 99 percent of the 1000 queries executed within a given second were executed within 158 milliseconds. In this example, if the QPS value is increased to 2000 queries, the traditional batch query techniques (e.g., executing batch queries using a single query engine on a backend database) return an error.

### Example Method

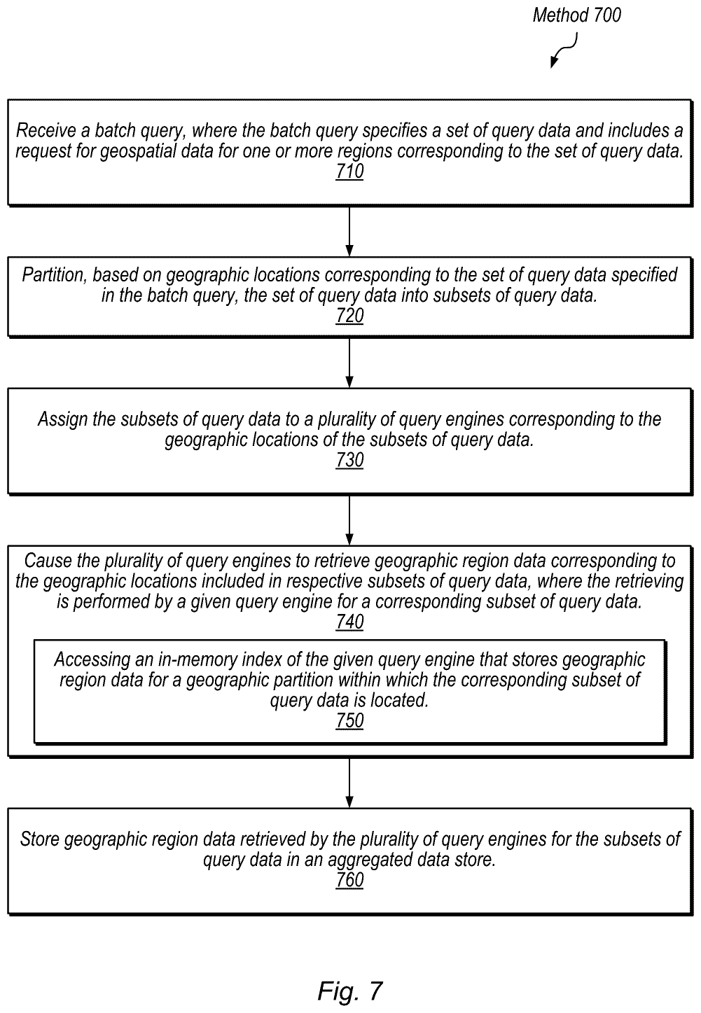

FIG. 7 is a flow diagram illustrating an example method for partitioning a batch query and executing the partitioned batch query using multiple query engines, according to some embodiments. The method 700 shown in FIG. 7 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired. In some embodiments, computer system 110 performs the elements of method 700.

At 710, in the illustrated embodiment, a computer system receives a batch query that specifies a set of query data and includes a request for geospatial data for one or more regions corresponding to the set of query data. In some embodiments, prior to receiving the batch query, the computer system builds in-memory indexes for each of the plurality of query engines based on previously received batch queries. In some embodiments, building the in-memory indexes includes dividing the surface of the earth into a plurality of cells with equal dimensions and mapping the cells to a plurality of geographic regions with one or more portions encompassed by the cells. In some embodiments, building the in-memory indexes further includes storing, in an in-memory index for respective ones of the cells, geographic data for regions having one or more portions encompassed by the respective ones of the cells. In some embodiments, the plurality of geographic regions include areas encompassing one or more of the following: a town, city, a state, a country, and a continent.

In some embodiments, generating a given in-memory index includes partitioning the plurality of batch queries into subsets of query data and assigning a first subset of query data to a first query engine. In some embodiments, generating the given in-memory index further includes retrieving, by the first query engine from one or more non-relational distributed databases, region data for a plurality of regions corresponding to geographic coordinates included in the first subset of query data. In some embodiments, generating the given in-memory index further includes storing, by the first query engine, the region data for the plurality of regions in an in-memory index of the first query engine.

At 720, the computer system partitions, based on geographic locations corresponding to the set of query data specified in the batch query, the set of query data into subsets of query data. As one example, the computer system breaks up the set of query data into four different subsets and assigns these four different partitioned subsets of query data to four different query engines for separate and efficient execution.

At 730, the computer system assigns the subsets of query data to a plurality of query engines corresponding to the geographic locations of the subsets of query data. For example, computer system assigns a given of subset of query data to a given query engine based on the geographic coordinates included in the given subset of query data being located in a region for which geographic data is indexed by the given query engine in an in-memory index. Said another way, the given query engine indexes data for a region in which the subset of the query data is located.

In some embodiments, the computer system is a distributed computing system, where the partitioning and the assigning performed are performed via a mapping procedure of the distributed computing system. In some embodiments, the executing is performed via summary procedure of the distributed computing system, where a number of query engines executed by the distributed computing system is determined based on an amount of data included in the set of query data specified in the batch query.

At 740, the computer system causes the plurality of query engines to retrieve geographic region data corresponding to the geographic locations included in respective subsets of query data. In some embodiments, the geographic region data includes one or more types of the following types of geographic variables: index number, creation timestamp, modification timestamp, region identifier, boundary type, and boundary coordinates. In some embodiments, the geographic region data retrieved by one or more of the plurality of query engines includes one or more types of the following types of geographic variables: city, state, population, population per square mile, region shape area, and region shape length.

At 750, the computer system performs the retrieving by executing a given query engine for a corresponding subset of query data by accessing an in-memory index of the given query engine that stores geographic region data for a geographic partition within which the corresponding subset of query data is located. In some embodiments, the set of query data included in the batch query includes a plurality of geographic coordinates, where the geographic region data retrieved for the given subset of query data includes data for a geographic region that encompasses a point specified by geographic coordinates included in the batch query.

At 760, the computer system stores geographic region data retrieved by the plurality of query engines for the subsets of query data in an aggregated data store. In some embodiments, the computer system transmits, to a computing device from which the batch query was received, a file path corresponding to the geographic region data stored in the aggregated data store for the batch query. In some embodiments, the aggregated data store is an online database cache.

In addition to method 700 and its variants, non-transitory, computer-readable media storing program instructions executable to implement such methods are also contemplated, along with systems configured to implement these methods.

The various techniques described herein may be performed by one or more computer programs. The term “program” is to be construed broadly to cover a sequence of instructions in a programming language that a computing device can execute. Computer system 110, shown in FIG. 1., may also be referred to herein as a “computer system” and is one example of the computing device that may execute various sequences of instructions that make up a program. These programs may be written in any suitable computer language, including lower-level languages such as assembly and higher-level languages such as Python. The program may be written in a compiled language such as C or C++, or an interpreted language such as JavaScript.

Program instructions may be stored on a “computer-readable storage medium” or a “computer-readable medium” in order to facilitate execution of the program instructions by a computer system, such as computer system 110 or system 600. Generally speaking, these phrases include any tangible or non-transitory storage or memory medium. The terms “tangible” and “non-transitory” are intended to exclude propagating electromagnetic signals, but not to otherwise limit the type of storage medium. Accordingly, the phrases “computer-readable storage medium” or a “computer-readable medium” are intended to cover types of storage devices that do not necessarily store information permanently (e.g., random access memory (RAM)). The term “non-transitory,” accordingly, is a limitation on the nature of the medium itself (i.e., the medium cannot be a signal) as opposed to a limitation on data storage persistency of the medium (e.g., RAM vs. ROM).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

Note that in some cases, program instructions may be stored on a storage medium but not enabled to execute in a particular computing environment. For example, a particular computing environment (e.g., a first computer system such as computer system 110) may have a parameter set that disables program instructions that are nonetheless resident on a storage medium of the first computer system. The recitation that these stored program instructions are “capable” of being executed is intended to account for and cover this possibility. Stated another way, program instructions stored on a computer-readable medium can be said to “executable” to perform certain functionality, whether or not current software configuration parameters permit such execution. Executability means that when and if the instructions are executed, they perform the functionality in question.

The present disclosure refers to various software operations that are performed in the context of one or more computer systems. Query engines 130A-B can each execute on respective computer systems, for example. Similarly, in-memory indexes 180A-N can be implemented on a computer system associated with geographic database 150. Each of these components, then, is implemented on physical structure (i.e., on computer hardware).

In general, any of the services or functionalities of a software development environment described in this disclosure can be performed by a host computing device, which is any computer system, such as computer system 110, that is capable of connecting to a computer network. A given host computing device can be configured according to any known configuration of computer hardware. A typical hardware configuration includes a processor subsystem, memory, and one or more I/O devices coupled via an interconnect. For example, computer system 110 receives batch queries from one or more client computing devices via an interconnect corresponding to an I/O device of computer system 110 and stores data in a memory, such as geographic database 150 or aggregated data store 170, as shown in FIG. 1. A given host computing device may also be implemented as two or more computer systems operating together.

The processor subsystem of the host computing device may include one or more processors or processing units. In some embodiments of the host computing device, multiple instances of a processor subsystem may be coupled to the system interconnect. The processor subsystem (or each processor unit within a processor subsystem) may contain any of various processor features known in the art, such as a cache, hardware accelerator, etc.

The system memory of the host computing device is usable to store program instructions executable by the processor subsystem to cause the host computing device to perform various operations described herein. The system memory may be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, etc.), read-only memory (PROM, EEPROM, etc.), and so on. Memory in the host computing device is not limited to primary storage. Rather, the host computing device may also include other forms of storage such as cache memory in the processor subsystem and secondary storage in the I/O devices (e.g., a hard drive, storage array, etc.). In some embodiments, these other forms of storage may also store program instructions executable by the processor subsystem.

The interconnect of the host computing device may connect the processor subsystem and memory with various I/O devices. One possible I/O interface is a bridge chip (e.g., Southbridge) from a front-side to one or more back-side buses. Examples of I/O devices include storage devices (hard drive, optical drive, removable flash drive, storage array, SAN, or their associated controller), network interface devices (e.g., to a computer network), or other devices (e.g., graphics, user interface devices.

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed is:

1. A method, comprising:
receiving, by a computer system, a batch query, wherein the batch query specifies a set of query data and includes a request for geospatial data for one or more regions corresponding to the set of query data;
partitioning, by the computer system based on geographic locations corresponding to the set of query data specified in the batch query, the set of query data into subsets of query data;
assigning, by the computer system, the subsets of query data to a plurality of query engines corresponding to the geographic locations of the subsets of query data; and
causing, by the computer system, the plurality of query engines to retrieve geographic region data corresponding to the geographic locations included in respective subsets of query data, wherein the retrieving is performed by a given query engine for a corresponding subset of query data by:
accessing an in-memory index of the given query engine that stores geographic region data for a geographic partition within which the corresponding subset of query data is located; and
storing, by the computer system, geographic region data retrieved by the plurality of query engines for the subsets of query data in an aggregated data store.

2. The method of claim 1, wherein prior to receiving the batch query, the computer system builds in-memory indexes for each of the plurality of query engines based on previously received batch queries.

3. The method of claim 2, wherein building the in-memory indexes includes:
dividing the surface of the earth into a plurality of cells with equal dimensions;
mapping the cells to a plurality of geographic regions with one or more portions encompassed by the cells; and
storing, in an in-memory index for respective ones of the cells, geographic data for regions having one or more portions encompassed by the respective ones of the cells.

4. The method of claim 3, wherein the plurality of geographic regions include areas encompassing one or more of the following: a town, city, a state, a country, and a continent.

5. The method of claim 1, wherein the set of query data included in the batch query includes a plurality of geographic coordinates, and wherein the geographic region data retrieved for the corresponding subset of query data includes data for a geographic region that encompasses a point specified by geographic coordinates included in the batch query.

6. The method of claim 1, further comprising:
transmitting, by the computer system to a computing device from which the batch query was received, a file path corresponding to the geographic region data stored in the aggregated data store for the batch query.

7. The method of claim 1, wherein the aggregated data store is an online database cache.

8. The method of claim 1, wherein the geographic region data includes one or more types of the following types of geographic variables: index number, creation timestamp, modification timestamp, region identifier, boundary type, and boundary coordinates.

9. The method of claim 1, wherein the computer system is a distributed computing system, wherein the partitioning and the assigning are performed via a mapping procedure of the distributed computing system, wherein the causing the plurality of query engines to retrieve geographic region data is performed via a summary procedure of the distributed computing system, and wherein a number of query engines executed by the distributed computing system is determined based on an amount of data included in the set of query data specified in the batch query.

10. A non-transitory computer-readable medium having instructions stored thereon that are executable by a computing device to perform operations comprising:
receiving a batch query requesting geospatial data for one or more geographic regions corresponding to locations specified by a set of geographic coordinates;
partitioning, based on the locations specified by the set of geographic coordinates specified in the batch query, the set of geographic coordinates into subsets of geographic coordinates;
assigning the subsets of geographic coordinates to a plurality of query engines corresponding to the locations specified by the set of geographic coordinates; and
causing the plurality of query engines to retrieve geographic region data corresponding to the locations specified by the subsets of geographic coordinates, wherein the retrieving is performed by a given query engine for a given subset of geographic coordinates by:
accessing an in-memory index of the given query engine that stores geographic region data for a geographic partition within which the given subset of geographic coordinates is located; and
storing geographic region data retrieved by the plurality of query engines for the subsets of geographic coordinates in an aggregated data store.

11. The non-transitory computer-readable medium of claim 10, wherein the geographic region data retrieved by one or more of the plurality of query engines includes one or more types of the following types of geographic variables: city, state, population, population per square mile, region shape area, and region shape length.

12. The non-transitory computer-readable medium of claim 10, wherein the operations further comprise:
prior to receiving the batch query, receiving a plurality of batch queries;
generating, by a plurality of query engines, a plurality of in-memory indexes, wherein generating a given in-memory index includes:
partitioning the plurality of batch queries into subsets of query data;
assigning a first subset of query data to a first query engine;
retrieving, by the first query engine from one or more non-relational distributed databases, region data for a plurality of regions corresponding to geographic coordinates included in the first subset of query data; and
storing, by the first query engine, the region data for the plurality of regions in an in-memory index of the first query engine.

13. The non-transitory computer-readable medium of claim 10, wherein the operation further comprise:
transmitting, to another computing device from which the batch query was received, a file path corresponding to the geographic region data stored in the aggregated data store for the batch query.

14. The non-transitory computer-readable medium of claim 10, wherein the geographic region data retrieved for the given subset of query data includes data for a geographic region that encompasses a point specified by geographic coordinates included in the batch query.

15. The non-transitory computer-readable medium of claim 10, wherein the computing device is a distributed computing system, wherein the partitioning and the assigning are performed via a mapping procedure of the distributed computing system, wherein the causing the plurality of query engines to retrieve geographic region data is performed via a summary procedure of the distributed computing system, and wherein a number of query engines executed by the distributed computing system is determined based on an amount of data included in the set of query data specified in the batch query.

16. A system, comprising:
a processor; and
a non-transitory computer-readable medium having stored thereon instructions that are executable by the processor to cause the system to perform operations comprising:
receiving a batch query, wherein the batch query specifies a set of query data and includes a request for geospatial data for one or more regions corresponding to the set of query data;
partitioning, based on geographic locations corresponding to the set of query data specified in the batch query, the set of query data into subsets of query data;
assigning the subsets of query data to a plurality of query engines corresponding to the geographic locations of the subsets of query data; and
causing the plurality of query engines to retrieve geographic region data corresponding to the geographic locations included in respective subsets of query data, wherein the retrieving is performed by a given query engine for a corresponding subset of query data by:
accessing an in-memory index of the given query engine that stores geographic region data for a geographic partition within which the corresponding subset of query data is located; and
storing geographic region data retrieved by the plurality of query engines for the subsets of query data in an aggregated data store.

17. The system of claim 16, wherein each of the plurality of query engines corresponds to a geographic partition, wherein each of the plurality of query engines are executable to build an in-memory index for the geographic partition for serving geographic data for geographic regions located within the geographic partition, and wherein a number of query engines executed by the system is determined based on an amount of data included in the set of query data specified in the batch query.

18. The system of claim 16, wherein prior to receiving the batch query, the system builds in-memory indexes for each of the plurality of query engines based on previously received batch queries.

19. The system of claim 18, wherein building the in-memory indexes includes:
dividing the surface of the earth into a plurality of cells with equal dimensions;
mapping the cells to a plurality of geographic regions with one or more portions encompassed by the cells; and
storing, in an in-memory index for respective ones of the cells, geographic data for regions having one or more portions encompassed by the respective ones of the cells.

20. The system of claim 16, wherein the geographic region data retrieved by one or more of the plurality of query engines includes one or more types of the following types of geographic variables: city, state, population, population per square mile, region shape area, and region shape length.
